(19) United States
(12) Patent Application Publication
(10) Pub. No.: US 2012/0258703 A1
(43) Pub. Date: Oct. 11, 2012

(54) DETECTION OF POTENTIAL FOR NETWORK CONTROLLED D2D COMMUNICATION PRIOR TO ACTIVATION OF CELLULAR BEARERS

(75) Inventors: Sami-Jukka Hakola, Kempele (FI); Timo Koskela, Oulo (FI); Samuli Turtinen, Ii (FI)

(73) Assignee: Renesas Mobile Corporation

(21) Appl. No.: 13/081,888

(22) Filed: Apr. 7, 2011

(51) Int. Cl. H04W 4/00

(52) U.S. Cl. 455/422.1

(57) ABSTRACT

The invention allows detection and evaluation of device-to-device (D2) potential prior to the establishment of a cellular connection between communicating mobile devices. Cellular radio access network information of an originating mobile device is obtained from a received session establishment message of session initiation signaling of cellular data communication. The obtained cellular radio access network information of the originating mobile device is compared to acquired cellular radio access network information of a terminating mobile device. Based on the comparison, it is detected whether the proximity between the originating mobile device and the terminating mobile device suffices to allow local cellular device-to-device data communication between the originating mobile device and the terminating mobile device.

### BACKGROUND OF THE INVENTION

1. Field of the Invention

The invention relates generally to mobile communications. In particular, the invention relates to methods, computer programs and apparatuses detection of potential for network controlled device-to-device (D2D) communication prior to activation of cellular bearers.

2. Description of the Related Art

A current development trend related to cellular communication systems is the integration of new network topologies into a cellular network. Examples include e.g. heterogeneous networks (i.e. deployment of e.g. macrocells, microcells, picocells, femtocells and relays in the same spectrum) in LTE/LTE-A of 3GPP.

As is known in the art, Long Term Evolution (LTE) was introduced in release 8 of 3^{rd} Generation Partnership Project (3GPP) which is a specification for 3^{rd} generation mobile communication systems. LTE is a technique for mobile data transmission that aims to increase data transmission rates and decrease delays, among other things. LTE uses orthogonal frequency division multiple access (OFDMA) as its multiple access method in the downlink. The uplink uses single-carrier frequency division multiple access (SD-FDMA). 3GPP release 10 introduced a next version of LTE, named LTE Advanced, fulfilling 4^{th} generation system requirements. The LTE architecture comprises an Evolved UMTS Radio Access Network, abbreviated by E-UTRAN.

One step further is to enable heterogeneous local communication directly among devices and machines under supervision of the network. One proposed way to implement this is so called device-to-device (D2D) communication.

The D2D communication functions as an underlay to a cellular network, operating on the same resources. Besides cellular operation, where user equipment (UE) is served by the network via the base stations, called evolved NodeBs (eNBs) in the LTE architecture, UE units may communicate directly with each other over the D2D links. The UEs in D2D connections remain controlled by the eNBs and continue cellular operation. The eNBs can control the resources used for cellular communications and by the D2D link.

Heterogeneous local communication may be implemented as network controlled D2D communication including communication in clusters of devices; (semi-) autonomous D2D communication in a cellular network; a grid/group of local machines communicating with each other while performing certain tasks in a co-operative way; and an advanced cellular device acting as a gateway for a group of low-capability devices or machines to access the network. Of these, the present invention relates to the network controlled D2D communication.

The selection of a D2D communication mode, and correspondingly the setting up of a D2D bearer, for communicating and closely located mobile devices can be divided into:
D2D bearer setup before actual data transfer exist in cellular mode between the mobile devices, i.e. D2D setup procedure is triggered from the initiation of an end-to-end (E2E) service between the mobile devices; and
D2D bearer setup from existing active cellular bearers that convey data of a common E2E service.

Of these, the present invention relates to the D2D bearer setup in case there are no existing active dedicated cellular bearers for the common E2E service between the mobile devices.

A problem is how and where the controlling network may notice the potential for D2D communication between mobile devices and trigger preparations for the D2D mode. Prior art solutions are based on radio level detection schemes, in which the detection can be performed only at a phase in which the dedicated cellular mode bearers are already being configured for both mobile devices. During this phase the controlling network may notice that the communicating mobile devices are e.g. in a same cell supervised by a same eNB. In such a case, if D2D mode is eventually selected, the cellular bearers need to be reconfigured again to be in D2D mode and all corresponding network side configurations need to be reconfigured. Furthermore, when session setups between mobile devices and between a mobile device and a server in e.g. LTE networks is carried out using Session Initiation Protocol (SIP), it may not be possible to detect e.g. in EUTRAN level (e.g. via MME extensions) the destination UE given in a SIP INVITE message sent over a default bearer on user plane, and thus to detect D2D potential in radio level prior to the establishment of a cellular connection between the communicating mobile devices.

For example the document 3GPP TR 24.930, “Signalling flows for the session setup in the IP Multimedia core network Subsystem (IMS) based on Session Initiation (SIP) and Session Initiation Protocol (SDP); Stage 3”, version 9.0.0, December 2009 (incorporated by reference herein) describes establishment of a session between two devices in the IP Multimedia core network Subsystem based on Session Initiation Protocol (SIP) and Session Description Protocol (SDP). A session is established in a situation where UE#1 and UE#2 do not yet have required local resources available and they need to perform resource reservation for dedicated bearers. The session initiation signaling is conveyed on established default bearers by both devices. Both the UE#1 and UE#2 will reserve dedicated resources in cellular communication mode. The session initiation between the two devices already requires a lot of signaling to be carried over radio and core networks, and conventionally it always leads to cellular communication mode even though the devices could have D2D potential. D2D can be setup afterwards, but signaling overhead could be significantly reduced if the D2D potential could be evaluated in a very early phase of the session setup.

Therefore, an object of the present invention is to alleviate the problems described above and to introduce a solution that allows detection and therefore evaluation of the D2D potential in a very early phase of the session setup, i.e. prior to the establishment of a cellular connection between the communicating mobile devices.

### SUMMARY OF THE INVENTION

A first aspect of the present invention is a method in which cellular radio access network information of an originating mobile device is obtained from a received session establishment message of session initiation signaling of cellular data communication. The obtained cellular radio access network information of the originating mobile device is compared to acquired cellular radio access network information of a terminating mobile device. Based on the comparison, it is detected whether the proximity between the originating mobile device and the terminating mobile device suffices to allow local cellular device-to-device data communication between the originating mobile device and the terminating mobile device.

A second aspect of the present invention is an apparatus which comprises an obtaining unit that is configured to obtain cellular radio access network information of an originating mobile device from a received session establishment message of session initiation signaling of cellular data communication. The apparatus further comprises a comparing unit that is configured to compare the obtained cellular radio access network information of the originating mobile device to acquired cellular radio access network information of a terminating mobile device. The apparatus further comprises a detecting unit that is configured to detect, based on the comparison, whether the proximity between the originating mobile device and the terminating mobile device suffices to allow local cellular device-to-device data communication between the originating mobile device and the terminating mobile device.

A third aspect of the present invention is a computer program stored on a computer-readable medium and comprising code adapted to cause the following when executed on a data-processing system:

obtaining cellular radio access network information of an originating mobile device from a received session establishment message of session initiation signaling of cellular data communication;

comparing the obtained cellular radio access network information of the originating mobile device to acquired cellular radio access network information of a terminating mobile device; and

detecting, based on the comparison, whether the proximity between the originating mobile device and the terminating mobile device suffices to allow local cellular device-to-device data communication between the originating mobile device and the terminating mobile device.

A fourth aspect of the present invention is an apparatus which comprises obtaining means for obtaining cellular radio access network information of an originating mobile device from a received session establishment message of session initiation signaling of cellular data communication. The apparatus further comprises comparing means for comparing the obtained cellular radio access network information of the originating mobile device to acquired cellular radio access network information of a terminating mobile device. The apparatus further comprises detecting means for detecting, based on the comparison, whether the proximity between the originating mobile device and the terminating mobile device suffices to allow local cellular device-to-device data communication between the originating mobile device and the terminating mobile device.

In an embodiment of the invention, cellular radio access network information comprises a radio cell identity of the respective mobile device, the comparing comprises comparing the radio cell identities of the respective mobile devices, and the detecting comprises detecting the proximity sufficing in response to at least one of: the compared radio cell identities being identical and the respective mobile devices being served by a same base station.

In an embodiment of the invention, cellular radio access network information comprises location information of the respective mobile device, the comparing comprises comparing the location information of the respective mobile devices, and the detecting comprises detecting the proximity sufficing in response to the compared location information indicating the distance between the respective mobile devices being under a predetermined value.

In an embodiment of the invention, location information comprises at least one of geographical location, a location area, and a mobility management node identity, of the respective mobile device.

In an embodiment of the invention, in response to the proximity having been detected to suffice, an evaluation request message is sent to a radio access network node for requesting evaluation of radio level capability for the local cellular device-to-device data communication between the originating mobile device and the terminating mobile device.

In an embodiment of the invention, the radio access network node comprises a mobility management node, and the obtaining further comprises obtaining an identity of the mobility management node from the received session establishment message.

In an embodiment of the invention, the evaluation request message comprises a radio resource control message.

In an embodiment of the invention, the invention is implemented at the terminating mobile device, and parameters are acquired from a session control node associated with the terminating mobile device for use in at least one of the comparing and the detecting.

In an embodiment of the invention, the invention is implemented at a session control node associated with the terminating mobile device, and the cellular radio access network information of the terminating mobile device is acquired from a message received from the terminating mobile device in response to the session establishment message having been forwarded to the terminating mobile device.

It is to be understood that the aspects and embodiments of the invention described above may be used in any combination with each other. Several of the aspects and embodiments may be combined together to form a further embodiment of the invention. A method, an apparatus, or a computer program which is an aspect of the invention may comprise at least one of the embodiments of the invention described above.

The invention allows detection and therefore evaluation of the D2D potential in a very early phase of the session setup, i.e. prior to the establishment of a cellular connection between the communicating mobile devices.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1a is a signaling diagram illustrating a method according to an embodiment of the invention;

FIG. 1a is a signaling diagram illustrating a method according to another embodiment of the invention;

FIG. 2a is a block diagram illustrating an apparatus according to an embodiment of the invention; and

FIG. 2b is a block diagram illustrating an apparatus according to another embodiment of the invention.

### DETAILED DESCRIPTION OF THE PREFERRED EMBODIMENTS

Reference will now be made in detail to the embodiments of the invention, examples of which are illustrated in the accompanying drawings.

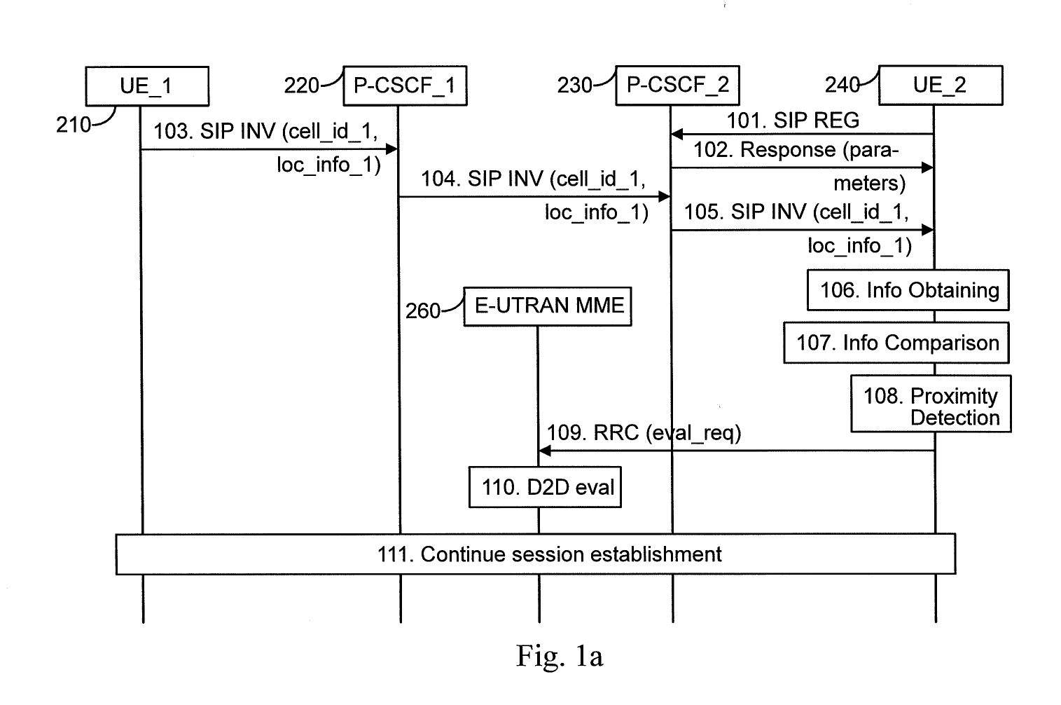

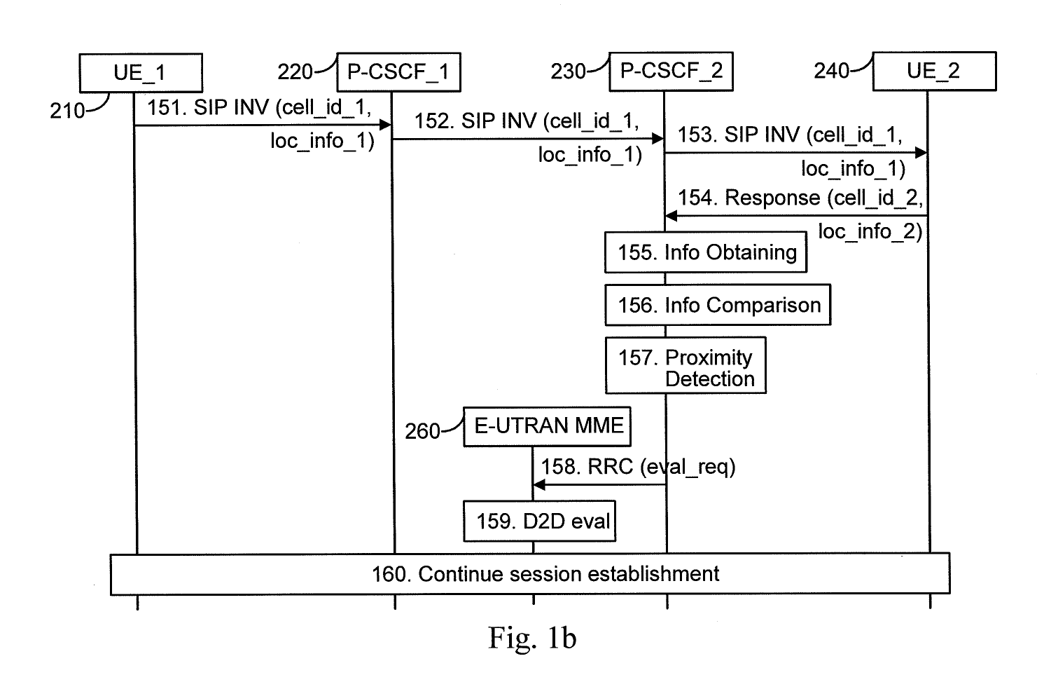

FIG. 1a is a signaling diagram illustrating a method according to an embodiment of the invention. As will be described below, in the embodiment of FIG. 1a comparison of obtained cellular radio access network information and proximity detection will be performed in a terminating mobile device 240.

In the following, the invention is illustrated using examples implemented in a network utilizing E-UTRAN and LTE/LTE-A based technology. However, it is to be understood that these examples are nonlimiting.

FIGS. 1a and 1b show an originating mobile device 210, a terminating mobile device 240, a session control node 220 associated with the originating mobile device 210, a session control node 230 associated with the terminating mobile device 240, and a radio network node 260.

The originating mobile device 210 is the mobile device that initiates a session establishment procedure, and terminating mobile device 240 is the recipient mobile device. The mobile devices 210, 240 may be e.g. mobile stations or mobile terminals.

The session control node 220 may comprise e.g. a Proxy Call Session Control Function (P-CSCF) or a SIP Proxy associated with the originating mobile device 210, and the session control node 230 may comprise e.g. a Proxy Call Session Control Function (PCSCF) or a SIP Proxy associated with the terminating mobile device 240.

The radio network node 260 may comprise a mobility management node, such as a Mobility Management Entity (MME).

Referring now to FIG. 1a, at steps 101-102, the terminating mobile device 240 acquires parameters from its associated session control node 230 for use in at least one of the comparing and detecting steps 107-108. This may be implemented for example as illustrated in FIG. 1a, i.e. the terminating mobile device 240 sends a registration message of Session Initiation Protocol (SIP) to the session control node 230, step 101. In response, session control node 230 sends the required parameters, step 102.

At step 103, the originating mobile device 210 initiates the session establishment procedure by sending a session establishment message of session initiation signaling of cellular data communication to its associated session control node 220. The session initiation signaling may comprise e.g. Session Initiation Protocol (SIP), and the session establishment message may comprise e.g. a SIP INVITE message. The session establishment message comprises cellular radio access network information of the originating mobile device 210. The cellular radio access network information of the originating mobile device 210 may comprise e.g. a radio cell identity of the originating mobile device 210. Additionally/alternatively, the cellular radio access network information of the originating mobile device 210 may comprise location information of the originating mobile device 210, such as a geographical location of the originating mobile device 210, and/or a location area of the originating mobile device 210. In an embodiment, the cellular radio access network information of the originating mobile device 210 may be comprised in a “p-Access-Network-Info” header of the SIP INVITE message. In an embodiment, the radio cell identity may be e.g. a “cell-id” element in the “p-Access-Network-Info” header.

At step 104, the session control node 220 forwards the session establishment message to the session control node 230 associated with the terminating mobile device 240. The session control node 230 in turn forwards the session establishment message to the terminating mobile device 240, step 105. It is worth noting that prior art allows the “p-Access-NetworkInfo” header to be included only until a serving proxy of a mobile device in its home network, i.e. until the session control node 220 in the embodiments of FIGS. 1a-1b.

Having received the session establishment message, the terminating mobile device 240 obtains the cellular radio access network information of the originating mobile device 210 from the received message, step 106. The terminating mobile device 240 also has access to its own cellular radio access network information.

At step 107, the terminating mobile device 240 compares the obtained cellular radio access network information of the originating mobile device 210 to its own cellular radio access network information.

In the embodiment of the cellular radio access network information comprising the radio cell identities of the originating mobile device 210 and the terminating mobile device 240, the comparison is performed by comparing the radio cell identities. Additionally/alternatively, if the cellular radio access network information comprises location information of the originating mobile device 210 and location information of the terminating mobile device 240, the comparison is additionally/alternatively performed by comparing the location information of the originating mobile device 210 to the location information of the terminating mobile device 240.

At step 108, the terminating mobile device 240 detects, based on the comparison, whether the proximity between the originating mobile device 210 and the terminating mobile device 240 suffices to allow local cellular device-to-device data communication between the originating mobile device 210 and the terminating mobile device 240.

For example, if the cellular radio access network information comprises the radio cell identities of the originating mobile device 210 and the terminating mobile device 240, it may be detected whether the radio cell identities are identical and/or whether the mobile devices 210, 240 are being served by a same base station (not illustrated in FIGS. 1a-1b). If the radio cell identities are identical and/or the mobile devices 210, 240 are being served by a same base station, it indicates that the mobile devices 210, 240 are close enough to each other to allow local cellular device-to-device (D2D) data communication between them.

Additionally/alternatively, if the cellular radio access network information comprises location information of the originating mobile device 210 and location information of the terminating mobile device 240, it may be detected whether the comparison between the location information of the originating mobile device 210 and the location information of the terminating mobile device 240 indicates that the distance between the originating mobile device 210 and the terminating mobile device 240 is under a predetermined value, thereby indicating that the mobile devices 210, 240 are close enough to each other to allow local cellular device-to-device (D2D) data communication between them. This allows evaluation of D2D potential for mobile devices that located closely but served by different base stations or eNBs.

At step 109, the terminating mobile device 240 sends, in response to the proximity having been detected to suffice at step 108, an evaluation request message to a radio access network node 260 for requesting evaluation of radio level capability for the local cellular device-to-device data communication between the originating mobile device and the terminating mobile device. The evaluation request message may comprise e.g. a radio resource control (RRC) message. The radio access network node 260 may be e.g. Mobility Management Entity (MME) of a E-UTRAN network, as discussed above. This could be implemented e.g. by defining new cross-layer/cross-plane procedure and signaling where predetermined SIP procedures would trigger predetermined RRC procedures within the terminating mobile device 240 to allow the above proximity detection. In addition, a new RRC level message could be implemented to convey the D2D evaluation request from the terminating mobile device 240 to the E-UTRAN.

At step 110, the radio access network node 260 may perform the evaluation of the radio level capability according to known prior art procedures, and thus it is not described in more detail herein.

At step ill, the session establishment procedure is continued according to known prior art procedures, and thus is not described in more detail herein.

FIG. 1b is a signaling diagram illustrating a method according to another embodiment of the invention. As will be described below, in the embodiment of FIG. 1b comparison of obtained cellular radio access network information and proximity detection will be performed in a session control node 230 associated with the terminating mobile device 240.

At step 151, the originating mobile device 210 initiates the session establishment procedure by sending a session establishment message of session initiation signaling of cellular data communication to its associated session control node 220. As with the embodiment of FIG. 1a, the session initiation signaling may comprise e.g. Session Initiation Protocol (SIP), and the session establishment message may comprise e.g. a SIP INVITE message. The session establishment message comprises cellular radio access network information of the originating mobile device 210. The cellular radio access network information of the originating mobile device 210 may comprise e.g. a radio cell identity of the originating mobile device 210. Additionally/alternatively, the cellular radio access network information of the originating mobile device 210 may comprise location information of the originating mobile device 210, such as a geographical location of the originating mobile device 210, and/or a location area of the originating mobile device 210. Additionally/alternatively, the cellular radio access network information of the originating mobile device 210 may comprise an identity of a mobility management node (such as a Mobility Management Entity (MME) of a E-UTRAN network) associated with the originating mobile device 210.

In an embodiment, the cellular radio access network information may be comprised in a “p-AccessNetwork-Info” header of the SIP INVITE message. In an embodiment, the radio cell identity may be e.g. a “cell-id” element in the “p-Access-Network-Info” header.

At step 152, the session control node 220 forwards the session establishment message to the session control node 230 associated with the terminating mobile device 240.

At steps 153-154, the session control node 230 acquires the cellular radio access network information of the terminating mobile device 240. This may be implemented for example as illustrated in FIG. 1b, i.e. the session control node 230 forwards the session establishment message to the terminating mobile device 240, step 153. In response to receiving the session establishment message, the terminating mobile device 240 sends a response message to the session control node 230, step 154. The response message may comprise e.g. a “100 Trying” message or a “183 Session Progress” message of SIP protocol. The response message further comprises the cellular radio access network information of the terminating mobile device 240.

The cellular radio access network information of the terminating mobile device 240 may comprise e.g. a radio cell identity of the terminating mobile device 240. Additionally/alternatively, the cellular radio access network information of the terminating mobile device 240 may comprise location information of the terminating mobile device 240, such as a geographical location of the terminating mobile device 240, and/or a location area of the terminating mobile device 240. Additionally/alternatively, the cellular radio access network information of the terminating mobile device 240 may comprise an identity of a mobility management node (such as a Mobility Management Entity (MME) of a E-UTRAN network) associated with the terminating mobile device 240. In an embodiment, the cellular radio access network information of the terminating mobile device 240 may be comprised in a “p-Access-NetworkInfo” header of the “100 Trying” message or the “183 Session Progress” message of SIP protocol. In an embodiment, the radio cell identity may be e.g. a “cell-id” element in the “p-Access-Network-Info” header.

Having received the session establishment message, the session control node 230 obtains the cellular radio access network information of the originating mobile device 210 from the received session establishment message, as well as the cellular radio access network information of the terminating mobile device 240 from the received response message, step 155. The session control node 230 may further obtain the identity of the mobility management node from the received session establishment message.

At step 156, the session control node 230 compares the obtained cellular radio access network information of the originating mobile device 210 to the acquired cellular radio access network information of the terminating mobile device 240.

In the embodiment of the cellular radio access network information comprising the radio cell identities of the originating mobile device 210 and the terminating mobile device 240, the comparison is performed by comparing the radio cell identities. Additionally/alternatively, if the cellular radio access network information comprises location information of the originating mobile device 210 and location information of the terminating mobile device 240, the comparison is additionally/alternatively performed by comparing the location information of the originating mobile device 210 to the location information of the terminating mobile device 240.

At step 157, the session control node 230 detects, based on the comparison of step 156, whether the proximity between the originating mobile device 210 and the terminating mobile device 240 suffices to allow local cellular device-to-device data communication between the originating mobile device 210 and the terminating mobile device 240.

For example, if the cellular radio access network information comprises the radio cell identities of the originating mobile device 210 and the terminating mobile device 240, it may be detected whether the radio cell identities are identical and/or whether the mobile devices 210, 240 are being served by a same base station (not illustrated in FIGS. 1a-1b). If the radio cell identities are identical and/or the mobile devices 210, 240 are being served by a same base station, it indicates that the mobile devices 210, 240 are close enough to each other to allow local cellular device-to-device (D2D) data communication between them.

Additionally/alternatively, if the cellular radio access network information comprises location information of the originating mobile device 210 and location information of the terminating mobile device 240, it may be detected whether the comparison between the location information of the originating mobile device 210 and the location information of the terminating mobile device 240 indicates that the distance between the originating mobile device 210 and the terminating mobile device 240 is under a predetermined value, thereby indicating that the mobile devices 210, 240 are close enough to each other to allow local cellular device-to-device (D2D) data communication between them.

At step 158, the session control node 230 sends, in response to the proximity having been detected to suffice at step 108, an evaluation request message to a radio access network node 260 for requesting evaluation of radio level capability for the local cellular device-to-device data communication between the originating mobile device and the terminating mobile device. The radio access network node 260 may be e.g. Mobility Management Entity (MME) of a EUTRAN network, as discussed above. As described above, once the session control node 230 detects that the originating mobile device 210 and the terminating mobile device 240 are served by the same eNB or the same MME, the session control node 230 may trigger the EUTRAN to configure a radio level evaluation for the possible D2D communication for the session under setup. For the triggering it may be feasible to include MME Identity into SIP INVITE since this allows defining a direct interface between IMS (IP Multimedia core network Subsystem) and MMES, and by using this interface a SIP Proxy would be able to contact the MME in question to trigger preparation or evaluation for possible D2D communication in radio level between the originating mobile device 210 and the terminating mobile device 240.

At step 159, the radio access network node 260 may perform the evaluation of the radio level capability according to known prior art procedures, and thus it is not described in more detail herein.

At step 160, the session establishment procedure is continued according to known prior art procedures, and thus is not described in more detail herein.

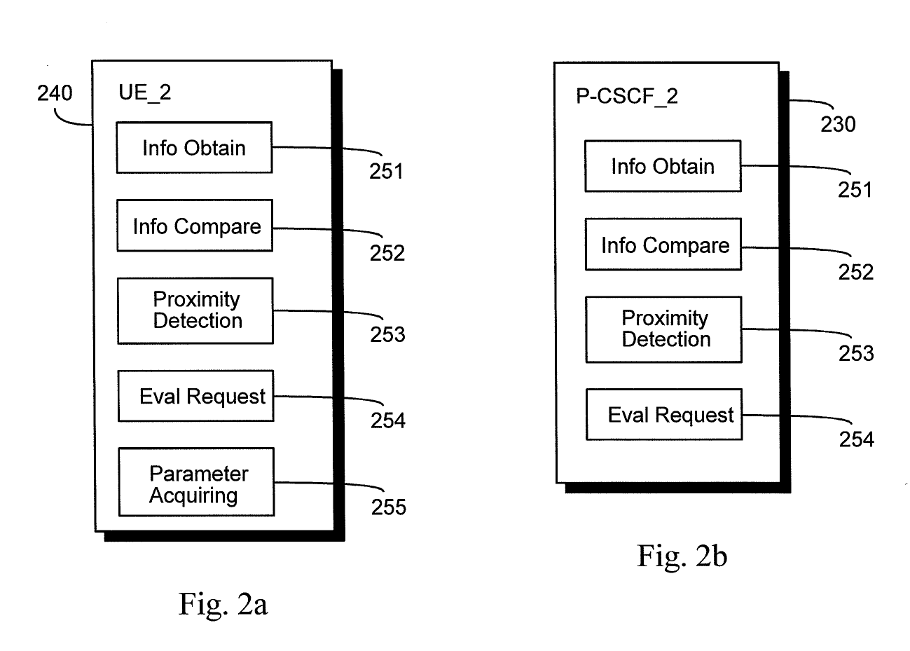

FIG. 2a illustrates an apparatus 240 according to an embodiment of the invention. The apparatus 240 may be comprised e.g. in a terminating mobile device.

The apparatus 240 comprises an obtaining unit 251 that is configured to obtain cellular radio access network information of an originating mobile device from a received session establishment message of session initiation signaling of cellular data communication. The apparatus 240 further comprises a comparing unit 252 that is configured to compare the obtained cellular radio access network information of the originating mobile device to acquired cellular radio access network information of a terminating mobile device. The apparatus 240 further comprises a detecting unit 253 that is configured to detect, based on the comparison, whether the proximity between the originating mobile device and the terminating mobile device suffices to allow local cellular device-to-device data communication between the originating mobile device and the terminating mobile device. The apparatus 240 further comprises an evaluation request unit 254 that is configured to send, in response to the proximity having been detected to suffice, an evaluation request message to a radio access network node for requesting evaluation of radio level capability for the local cellular device-to-device data communication between the originating mobile device and the terminating mobile device. The apparatus 240 further comprises a parameter acquiring unit 255 that is configured to acquire parameters from a session control node associated with the terminating mobile device for use by at least one of the comparing unit and detecting unit. The obtaining unit 251, the comparing unit 252, the detecting unit 253, the evaluation request unit 254 and the parameter acquiring unit 255 may be implemented in hardware, in software, or in a combination thereof.

FIG. 2b illustrates an apparatus 230 according to an embodiment of the invention. The apparatus 230 may be comprised e.g. in session control node associated with a terminating mobile device.

The apparatus 230 comprises an obtaining unit 251 that is configured to obtain cellular radio access network information of an originating mobile device from a received session establishment message of session initiation signaling of cellular data communication. The apparatus 230 further comprises a comparing unit 252 that is configured to compare the obtained cellular radio access network information of the originating mobile device to acquired cellular radio access network information of a terminating mobile device. The apparatus 230 further comprises a detecting unit 253 that is configured to detect, based on the comparison, whether the proximity between the originating mobile device and the terminating mobile device suffices to allow local cellular device-to-device data communication between the originating mobile device and the terminating mobile device. The apparatus 230 further comprises an evaluation request unit 254 that is configured to send, in response to the proximity having been detected to suffice, an evaluation request message to a radio access network node for requesting evaluation of radio level capability for the local cellular device-to-device data communication between the originating mobile device and the terminating mobile device. The obtaining unit 251, the comparing unit 252, the detecting unit 253 and the evaluation request unit 254 may be implemented in hardware, in software, or in a combination thereof.

The exemplary embodiments can include, for example, any suitable servers, workstations, PCs, laptop computers, personal digital assistants (PDAs), Internet appliances, handheld devices, cellular telephones, smart phones, wireless devices, other devices, and the like, capable of performing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, 3 G communications networks, Public Switched Telephone Network (PSTNs), Packet Data Networks (PDNs), the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware and/or software art(s). For example, the functionality of one or more of the components of the exemplary embodiments can be implemented via one or more hardware and/or software devices.

The exemplary embodiments can store information relating to various processes described herein.

This information can be stored in one or more memories, such as a hard disk, optical disk, magnetooptical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be conveniently implemented using one or more general purpose processors, microprocessors, digital signal processors, micro-controllers, and the like, programmed according to the teachings of the exemplary embodiments of the present inventions, as will be appreciated by those skilled in the computer and/or software art(s). Appropriate software can be readily prepared by programmers of ordinary skill based on the teachings of the exemplary embodiments, as will be appreciated by those skilled in the software art. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware and/or software.

Stored on any one or on a combination of computer readable media, the exemplary embodiments of the present inventions can include software for controlling the components of the exemplary embodiments, for driving the components of the exemplary embodiments, for enabling the components of the exemplary embodiments to interact with a human user, and the like.

Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the components of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, trans-mission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CD+R, CD+RW, DVD, DVD-RAM, DVD+RW, DVD+R, HD DVD, HD DVD-R, HD DVD-RW, HD DVD-RAM, Blu-ray Disc, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

What is claimed is:

1. A method, comprising:
obtaining cellular radio access network information of an originating mobile device from a received session establishment message of session initiation signaling of cellular data communication;
comparing the obtained cellular radio access network information of the originating mobile device to acquired cellular radio access network information of a terminating mobile device; and
detecting, based on the comparison, whether the proximity between the originating mobile device and the terminating mobile device suffices to allow local cellular device-to-device data communication between the originating mobile device and the terminating mobile device.

2. The method according to claim 1, wherein cellular radio access network information comprises a radio cell identity of the respective mobile device, the comparing comprises comparing the radio cell identities of the respective mobile devices, and the detecting comprises detecting the proximity sufficing in response to at least one of: the compared radio cell identities being identical and the respective mobile devices being served by a same base station.

3. The method according to claim 1, wherein cellular radio access network information comprises location information of the respective mobile device, the comparing comprises comparing the location information of the respective mobile devices, and the detecting comprises detecting the proximity sufficing in response to the compared location information indicating the distance between the respective mobile devices being under a predetermined value.

4. The method according to claim 3, wherein location information comprises at least one of geographical location, a location area, and a mobility management node identity, of the respective mobile device.

5. The method according to claim 1, further comprising sending, in response to the proximity having been detected to suffice, an evaluation request message to a radio access network node for requesting evaluation of radio level capability for the local cellular device-to-device data communication between the originating mobile device and the terminating mobile device.

6. The method according to claim 5, wherein the radio access network node comprises a mobility management node, and the obtaining further comprises obtaining an identity of the mobility management node from the received session establishment message.

7. The method according to claim 5, wherein the evaluation request message comprises a radio resource control message.

8. The method according to claim 1, wherein the method is performed at the terminating mobile device, and the method further comprises acquiring parameters from a session control node associated with the terminating mobile device for use in at least one of the comparing and detecting steps.

9. The method according to claim 1, wherein the method is performed at a session control node associated with the terminating mobile device, and the method further comprises acquiring the cellular radio access network information of the terminating mobile device from a message received from the terminating mobile device in response to the session establishment message having been forwarded to the terminating mobile device.

10. An apparatus, comprising:
an obtaining unit configured to obtain cellular radio access network information of an originating mobile device from a received session establishment message of session initiation signaling of cellular data communication;
a comparing unit configured to compare the obtained cellular radio access network information of the originating mobile device to acquired cellular radio access network information of a terminating mobile device; and
a detecting unit configured to detect, based on the comparison, whether the proximity between the originating mobile device and the terminating mobile device suffices to allow local cellular device-to-device data communication between the originating mobile device and the terminating mobile device.

11. The apparatus according to claim 10, wherein cellular radio access network information comprises a radio cell identity of the respective mobile device, the comparing unit is configured to perform the comparison by comparing the radio cell identities of the respective mobile devices, and the detecting unit is configured to perform the detecting by detecting the proximity sufficing in response to at least one of: the compared radio cell identities being identical and the respective mobile devices being served by a same base station.

12. The apparatus according to claim 10, wherein cellular radio access network information comprises location information of the respective mobile device, the comparing unit is configured to perform the comparison by comparing the location information of the respective mobile devices, and the detecting unit is configured to perform the detecting by detecting the proximity sufficing in response to the compared location information indicating the distance between the respective mobile devices being under a predetermined value.

13. The apparatus according to claim 12, wherein location information comprises at least one of geographical location, a location area, and a mobility management node identity, of the respective mobile device.

14. The apparatus according to claim 10, further comprising an evaluation request unit configured to send, in response to the proximity having been detected to suffice, an evaluation request message to a radio access network node for requesting evaluation of radio level capability for the local cellular device-to-device data communication between the originating mobile device and the terminating mobile device.

15. The apparatus according to claim 14, wherein the radio access network node comprises a mobility management node, and the obtaining unit is further configured to obtain an identity of the mobility management node from the received session establishment message.

16. The apparatus according to claim 14, wherein the evaluation request message comprises a radio resource control message.

17. The apparatus according to claim 10, wherein the apparatus is comprised in the terminating mobile device, and the apparatus further comprises a parameter acquiring unit configured to acquire parameters from a session control node associated with the terminating mobile device for use by at least one of the comparing unit and detecting unit.

18. The apparatus according to claim 10, wherein the apparatus is comprised in a session control node associated with the terminating mobile device, and the obtaining unit is further configured to acquire the cellular radio access network information of the terminating mobile device from a message received from the terminating mobile device in response to the session establishment message having been forwarded to the terminating mobile device.

19. A computer program stored on a computer-readable medium and comprising code adapted to cause the following when executed on a data-processing system:
obtaining cellular radio access network information of an originating mobile device from a received session establishment message of session initiation signaling of cellular data communication;
comparing the obtained cellular radio access network information of the originating mobile device to acquired cellular radio access network information of a terminating mobile device; and
detecting, based on the comparison, whether the proximity between the originating mobile device and the terminating mobile device suffices to allow local cellular device-to-device data communication between the originating mobile device and the terminating mobile device.
